(19) United States
(12) Patent Application Publication
(10) Pub. No.: US 2017/0000307 A1
(43) Pub. Date: Jan. 5, 2017

(54) USER EQUIPMENT, CLEANING ROBOT INCLUDING THE SAME, AND METHOD FOR CONTROLLING CLEANING ROBOT

(71) Applicant: SAMSUNG ELECTRONICS CO., LTD., Suwon-si (KR)

(72) Inventors: Min Yong CHOI, Suwon-si (KR); No San KWAK, Suwon-si (KR); Ji Min KIM, Seoul (KR); Kyung Shik ROH, Seongnam-si (KR); Soon Yong PARK, Bucheon-si (KR); Suk June YOON, Seoul (KR); So Hee LEE, Seoul (KR)

(73) Assignee: SAMSUNG ELECTRONICS CO., LTD., Suwon-si (KR)

(21) Appl. No.: 15/171,341

(22) Filed: Jun. 2, 2016

(30) Foreign Application Priority Data
Jul. 2, 2015 (KR) 10-2015-0094567

(51) Int. Cl. A47L 11/40; H04B 17/318; G05D 1/00; H04W 4/04

(52) U.S. Cl. CPC A47L 11/4011; H04W 4/043; H04B 17/318; G05D 1/0016; G05D 1/0022; G05D 2201/0203; A47L 2201/00

(57) ABSTRACT

Disclosed is a user equipment (UE), cleaning robot including the same, and method for controlling the cleaning robot, which is intended for a cleaning robot to move to a place where there is the user by the user transmitting a radio communication signal to the cleaning robot and the cleaning robot estimating a location from which the radio communication signal is transmitted based on attenuation ratios of signal intensities over distance. An embodiment of the cleaning robot includes a main body; a moving unit for moving the main body; a communication unit for performing wireless communication with a user equipment (UE); and a robot controller for determining a location of the UE based on intensity of a radio communication signal received by the communication unit, wherein the robot controller controls the moving unit to move the main body to the determined location of the UE once the location of the UE is determined.

### CROSS-REFERENCE TO RELATED APPLICATIONS

This application claims the benefit under 35 U.S.C. §119(a) of a Korean patent application filed on Jul. 2, 2015 in the Korean Intellectual Property Office and assigned Serial No. 10-2015-0094567, the entire disclosure of which is incorporated hereby incorporated by reference.

### BACKGROUND

1. Field

The present disclosure relates to a user equipment (UE), cleaning robot including the UE, and method for controlling the cleaning robot, by which a cleaning robot is moved to a point called by a user according to the user's call command.

2. Description of the Related Art

A cleaning robot is a device that automatically cleans a room by sucking up impurities, such as dust on the floor while autonomously moving about the room without user intervention. That is, the cleaning robot cleans the room while moving around the room.

In general, the cleaning robot automatically cleans the room along a route planned in the cleaning robot regardless of the intention of the user.

To make the cleaning robot perform cleaning under the intention of the user, there is a method for the user to directly control the cleaning robot with a control device after putting the cleaning robot under a manual operation mode.

In the method, the user may also designate a position to which the cleaning robot is to be moved by irradiating light by means of the control device, and the cleaning robot may recognize the light and move to the position desired by the user.

Recently, methods for controlling the cleaning robot are being actively studied, by which the user transmits a radio communication signal to the cleaning robot to give a call command and upon reception of the radio communication signal, the cleaning robot moves to a point called by the user.

### SUMMARY

The present disclosure provides a user equipment (UE), cleaning robot including the same, and method for controlling the cleaning robot, which is intended for a cleaning robot to move to a place where there is the user by the user transmitting a radio communication signal to the cleaning robot and the cleaning robot estimating a location from which the radio communication signal is transmitted based on attenuation ratios of signal intensities over distance.

In accordance with an aspect of the present disclosure, a cleaning robot is provided. The cleaning robot includes a main body; a moving unit for moving the main body; a communication unit for performing wireless communication with a user equipment (UE); and a robot controller for determining a location of the UE based on intensity of a radio communication signal received by the communication unit, wherein the robot controller controls the moving unit to move the main body to the determined location of the UE once the location of the UE is determined.

The communication unit may include at least one receiving module for receiving a radio communication signal from the UE; and a transmitting module for transmitting a radio communication signal to the UE.

The robot controller may determine that a distance between the UE and the main body decreases as the intensity of the radio communication signal increases, and determine that a distance between the UE and the main body increases as the intensity of the radio communication signal decreases.

The robot controller may determine a direction of the UE using information about a distance between the UE and the main body determined based on the intensity of a radio communication signal received by the receiving module multiple times while the main body is on the move.

The robot controller may determine a direction of the UE by detecting a point of intersection between a plurality of coordinate values corresponding to a distance between the UE and the main body when the main body is at a first location and a plurality of coordinate values corresponding to a distance between the UE and the main body when the main body is at a second location.

The robot controller may determine a direction of the UE using information about a distance between the UE and the main body determined based on the intensity of the radio communication signal received by each receiving module if the at least one receiving module is provided in plural.

The transmitting module may transmit at least one piece of information about whether the receiving module has received the radio communication signal, whether the main body is moving, or whether the main body has arrived at the determined location of the UE to the UE.

The cleaning robot may further include a storage for storing information about correlations in which the intensity of the radio communication signal varies with the distance between the UE and the main body.

In accordance with another aspect of the present disclosure, a method for controlling a cleaning robot that includes a main body, a moving unit for moving the main body, and at least one receiving module for receiving a radio communication signal from the UE is provided. The method includes receiving a radio communication signal from the UE; determining a location of the UE based on intensity of the received radio communication signal; and controlling the moving unit to move the main body to the determined location of the UE based on the determined location of the UE.

The determining of a location of the UE based on intensity of the received radio communication signal may include determining that a distance between the UE and the main body decreases as the intensity of the radio communication signal increases, and determining that a distance between the UE and the main body increases as the intensity of the radio communication signal decreases.

The determining of a location of the UE based on intensity of the received radio communication signal may include determining a direction of the UE using information about a distance between the UE and the main body determined based on intensity of a radio communication signal received multiple times while the main body is on the move.

The determining of a direction of the UE may include detecting a point of intersection between a plurality of coordinate values corresponding to a distance between the UE and the main body when the main body is at a first location and a plurality of coordinate values corresponding to a distance between the UE and the main body when the main body is at a second location.

The determining of a direction of the UE may include determining a direction of the UE using information about a distance between the UE and the main body determined based on the intensity of the radio communication signal received by each receiving module if there are multiple receiving modules.

The method may further include transmitting a radio communication signal to the UE.

The transmitting of a radio communication signal to the UE may include transmitting at least one piece of information about whether the receiving module has received the radio communication signal, whether the main body is moving, or whether the main body has arrived at the determined location of the UE to the UE.

In accordance with another aspect of the present disclosure, a user equipment (UE) is provided. The UE includes a transmitter for transmitting a radio communication signal to call a cleaning robot to a location of the UE; a receiver for receiving a radio communication signal about a state of operation of the cleaning robot from the cleaning robot; and a display unit for displaying a state of operation of the cleaning robot based on a radio communication signal received from the cleaning robot.

The display unit may display at least one of whether the cleaning robot has received the radio communication signal, whether the cleaning robot is moving, or whether the cleaning robot has arrived at a location of the UE.

The transmitter may transmit a radio communication signal multiple times while the cleaning robot has moved toward the UE.

The UE may further include an input unit for receiving a command to transmit a radio communication signal to call the cleaning robot to a location of the UE to the cleaning robot.

The UE may further include a microprocessor for controlling to transmit the radio communication signal to the cleaning robot based on the command received through the input unit, and to display a state of operation of the cleaning robot based on a radio communication signal received from the cleaning robot.

Other aspects, advantages, and salient features of the disclosure will become apparent to those skilled in the art from the following detailed description, which, taken in conjunction with the annexed drawings, discloses exemplary embodiments of the disclosure.

### BRIEF DESCRIPTION OF THE DRAWINGS

The above and other features and advantages of the present disclosure will become more apparent by describing in detail exemplary embodiments thereof with reference to the attached drawings in which:

FIG. 1 illustrates a user transmitting a radio communication signal to a cleaning robot, according to an embodiment of the present disclosure;

FIG. 2 illustrates a user calling a cleaning robot to move to a position desired by the user, according to an embodiment of the present disclosure;

FIGS. 3A and 3B are graphs in a coordinate system representing attenuation ratios of signal intensities over distance between a user equipment (UE) and a cleaning robot in case of transmitting a radio communication signal, according to an embodiment of the present disclosure;

FIG. 4 is a control block diagram of a UE and cleaning robot, according to an embodiment of the present disclosure;

FIG. 5 is a perspective view of the exterior of a cleaning robot, according to an embodiment of the present disclosure;

FIGS. 6 and 7 are perspective views of the interior of a cleaning robot, according to an embodiment of the present disclosure;

FIG. 8 is a perspective view of the bottom of a cleaning robot, according to an embodiment of the present disclosure;

FIG. 9 is a perspective view of the exterior of a UE, according to an embodiment of the present disclosure;

FIG. 10 conceptually illustrates a cleaning robot receiving a radio communication signal with a single receiving module, according to an embodiment of the present disclosure;

FIG. 11 illustrates a coordinate plane conceptually representing a method for determining a direction of a UE by combining pieces of distance information between the UE and a cleaning robot with a single receiving module, according to an embodiment of the present disclosure;

FIG. 12 conceptually illustrates a cleaning robot receiving radio communication signals with two receiving modules, according to an embodiment of the present disclosure;

FIG. 13 illustrates a coordinate plane conceptually representing a method for determining a direction of a UE by combining pieces of distance information between the UE and a cleaning robot with two receiving modules, according to an embodiment of the present disclosure;

FIG. 14 illustrates a display unit of a UE displaying whether a cleaning robot has received a radio communication signal from the UE, according to an embodiment of the present disclosure;

FIG. 15 illustrates a display unit of a UE displaying whether a cleaning robot is moving to a position of a user, according to an embodiment of the present disclosure;

FIG. 16 illustrates a display unit of a UE displaying whether a cleaning robot has arrived at a position of the UE, according to an embodiment of the present disclosure;

FIG. 17 conceptually illustrates a UE remotely controlling a cleaning robot, according to an embodiment of the present disclosure; and

FIG. 18 is a flowchart illustrating a method for controlling a cleaning robot, according to an embodiment of the present disclosure.

Throughout the drawings, like reference numerals will be understood to refer to like parts, components, and structures.

### DETAILED DESCRIPTION

Advantages, features, and methods for achieving them will be understood more clearly when the following embodiments are read with reference to the accompanying drawings.

Embodiments and features as described and illustrated in the present disclosure are only preferred examples, and various modifications thereof may also fall within the scope of the disclosure.

The terminology used herein is for the purpose of describing particular embodiments only and is not intended to limit the present disclosure. It is to be understood that the singular forms “a,” “an,” and “the” include plural references unless the context clearly dictates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The terms including ordinal numbers like “first” and “second” may be used to explain various components, but the components are not limited by the terms. The terms are only for the purpose of distinguishing a component from another. Thus, a first element, component, region, layer or section discussed below could be termed a second element, component, region, layer or section without departing from the teachings of the present disclosure. Descriptions shall be understood as to include any and all combinations of one or more of the associated listed items when the items are described by using the conjunctive term “˜and/or ˜,” or the like.

Embodiments of a user equipment (UE), cleaning robot including the UE, and method for controlling the cleaning robot will now be described in detail with reference to accompanying drawings. Like reference numerals refer to like components throughout the drawings, and thus the related descriptions that overlap will be omitted.

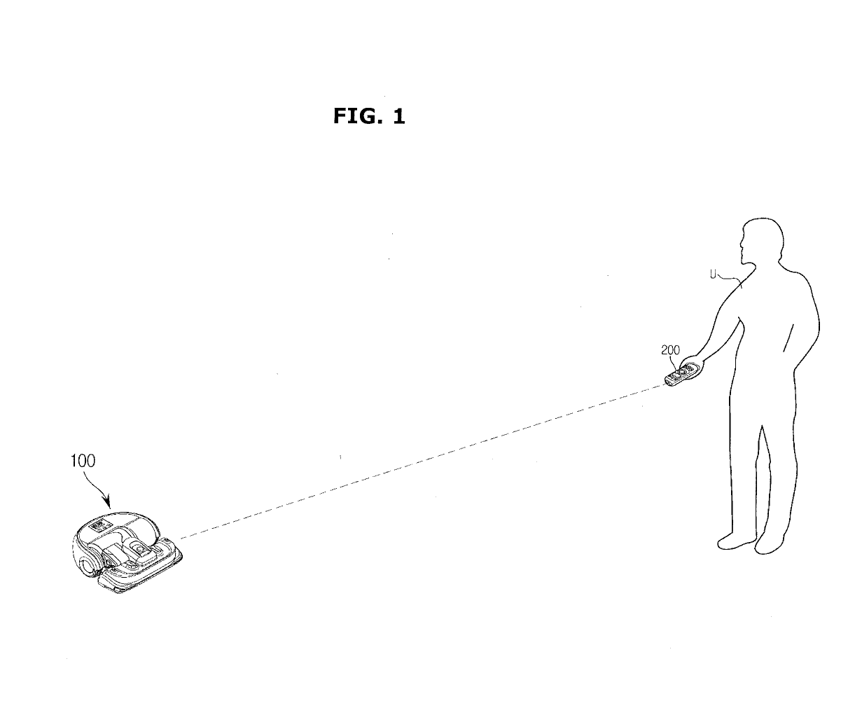

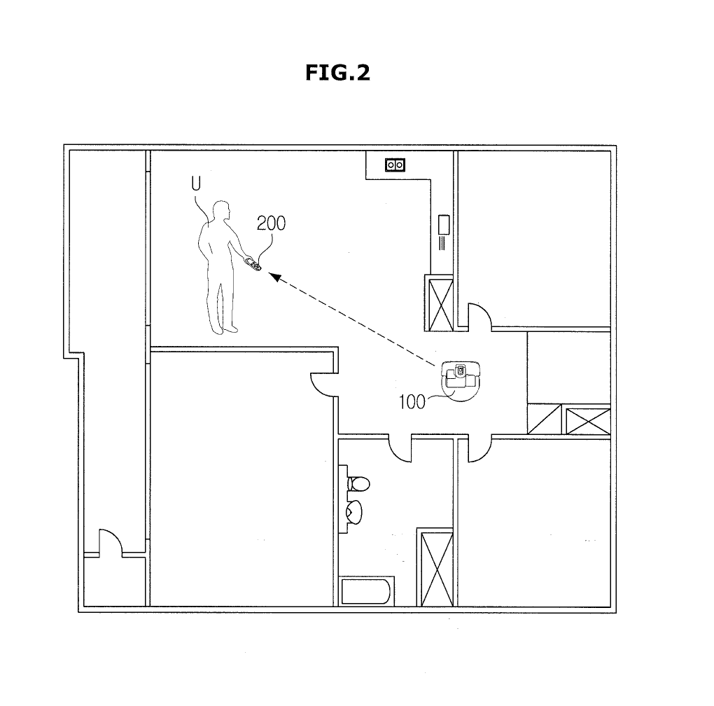

FIG. 1 illustrates a user transmitting a radio communication signal to a cleaning robot, according to an embodiment of the present disclosure, and FIG. 2 illustrates a user calling a cleaning robot to move to a position desired by the user, according to an embodiment of the present disclosure.

Referring to FIG. 1, a UE 200 may be used to transmit a radio communication signal to a cleaning robot 100. The cleaning robot 100 may clean a room while moving around the room, and the UE 200 may receive an operation command from the user and forward the operation command to the cleaning robot 100 via wireless communication. The UE 200 may employ a dedicated remote controller manufactured to control the cleaning robot 100 or a portable terminal capable of performing voice communication and data communication with various devices through wireless communication. Various communication schemes, such as Radio Frequency (RF), Wireless Fidelity (Wi-Fi), Bluetooth, Zigbee, near field communication (NFC), Ultra Wide Band (UWB) communications, etc., may be employed for the wireless communication, but are not limited thereto as long as the UE 200 and the cleaning robot 100 may exchange wireless communication signals. Conventionally, the cleaning robot 100 performs automatic cleaning along an internally set cleaning route, and to allow a user U to control the cleaning operation of the cleaning robot 100, the user U may manually set the cleaning robot 100 to be in a manual operation mode and then use a control key or keys on the UE 200 to manually control the cleaning robot 100. Alternatively, the cleaning robot 100 may perform cleaning by moving to follow a light spot originated from a light source of the UE 200.

In the former case that the user manually controls the cleaning robot 100, the user needs to manipulate the control key on the UE 200, and the user, as an average user, may often find it difficult to manipulate the key. In the latter case that the cleaning robot 100 moves to follow a light spot originated from the light source of the UE 200, the user may intuitively control the cleaning robot 100, but if the UE 200 and the cleaning robot 100 are far away from each other or there is an obstruction between them, the cleaning robot 100 may not detect the light spot, i.e., the light spot-based control method is used only when the UE 200 and the cleaning robot 100 are located adjacent to each other.

In accordance with an embodiment of the present disclosure, the user may send a call command to call the cleaning robot 100 in the form of a radio communication signal by using the UE 200 at a desired location, and the cleaning robot 100 may move to the location where the user is located upon reception of the radio communication signal. That is, the user does not need to manually control movement of the cleaning robot 100 with the UE 200. Furthermore, since the radio communication signal has a long range of propagation and may be transmitted and received even if there is an obstacle in between, the user may easily call the cleaning robot 100 even if the UE 200 is far away from the cleaning robot 100.

Although FIGS. 1 and 2, for convenience of explanation, show as if the user uses the UE 200 to transmit a radio communication signal toward the cleaning robot 100, there are no limitations on a method for inputting a control command to transmit the radio communication signal through the UE 200, and the user may use a manipulation key on the UE 200 where the user is located, to transmit the radio communication signal.

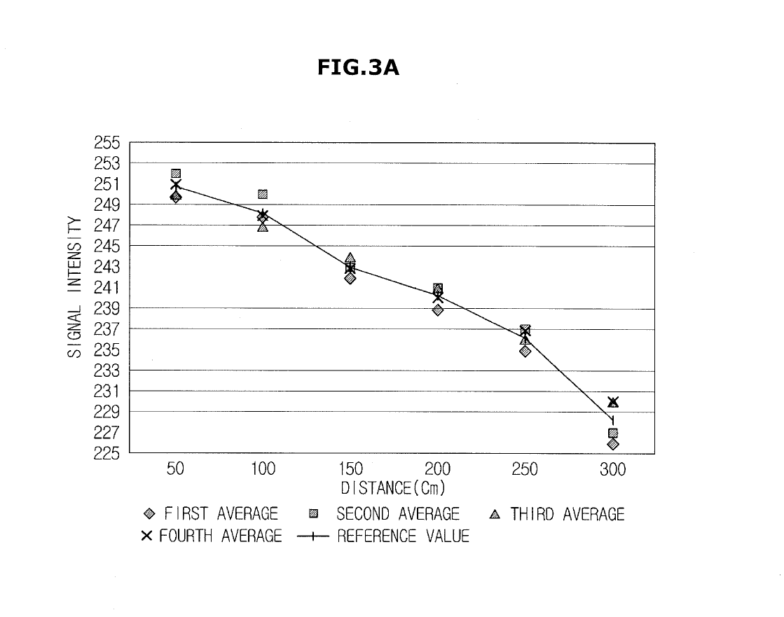

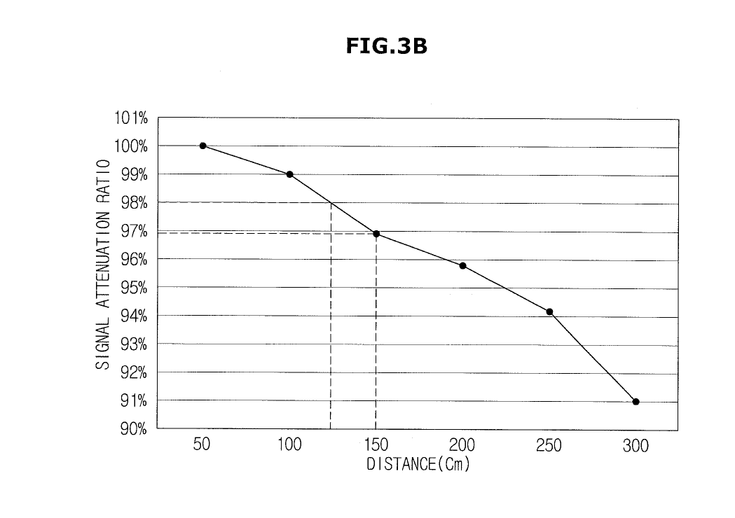

FIGS. 3A and 3B are graphs in a coordinate system representing attenuation ratios of signal intensities over distance between a UE and a cleaning robot in case of transmitting a radio communication signal, according to an embodiment of the present disclosure.

A method for determining a distance between the UE 200 and the cleaning robot 100 based on a radio communication signal exchanged between the UE 200 and the cleaning robot 100 may include determining the distance based on a time gap between transmission by the UE 200 and reception by the cleaning robot 100 of the radio communication signal, or based on properties of attenuation of the intensity of the radio communication signal over distance.

Referring to FIG. 3A, the radio communication signal transmitted from the UE 200 becomes weaker as the distance to the cleaning robot 100 becomes longer. As shown in FIG. 3A, intensities of the radio communication signal received by the cleaning robot 100 may be measured at intervals of 50 cm, e.g., at 50 cm, 100 cm, . . . , 300 cm distances between the cleaning robot 100 and the UE 200. In FIG. 3A, the y-axis represents intensities of the radio communication signal received by the cleaning robot 100, and the x-axis represents distances between the cleaning robot 100 and the UE 200.

As shown in FIG. 3A, the intensity of the radio communication signal is attenuated in inverse proportion to the distance, but not necessarily inverse proportion to the square of the distance between the UE 200 and the cleaning robot 100.

Data about the attenuation ratio of the radio communication signal may be obtained by averaging several measurements. A signal intensity measurement may be obtained not by measuring a signal at a moment but by averaging intensities of signals received for a certain period of time. For example, if the UE 200 is about 50 cm away from the cleaning robot 100, a measurement may be determined by averaging intensities of radio communication signals received by the cleaning robot 100 for 3 seconds. A point represented in the coordinate system of FIG. 3A indicates a measurement obtained in the aforementioned averaging manner.

For each reference distance between the UE 200 and the cleaning robot 100, a measurement obtained by measuring one time in the averaging manner corresponds to a first average, and measurements obtained by repeatedly measuring, i.e., measuring second time, third time, or fourth time correspond to a second average, a third average, or a fourth average. The linear graph shown in FIG. 3A is obtained by calculating a total average of the first to fourth averages and linking the respective points.

FIG. 3B is a graph showing attenuation ratios of the radio communication signal in the y-axis. Referring to FIG. 3B, given that a signal intensity at the distance of 50 cm between the UE 200 and the cleaning robot 100 is a reference intensity, values obtained by dividing intensities of the radio communication signal measured at respective reference distances between the UE 200 and the cleaning robot 100 by the reference intensity and represented in percentages correspond to the attenuation ratios. Accordingly, FIG. 3B shows data of the attenuation ratios representing how much the intensity of the radio communication signal is attenuated at the respective reference distances. Although the attenuation ratios of the radio communication signal are represented on a coordinate axis, it may be represented in the form of data, e.g., in data pairs such as (50, 100%), (100, 99%), (150, 97%), . . . , (300, 91%).

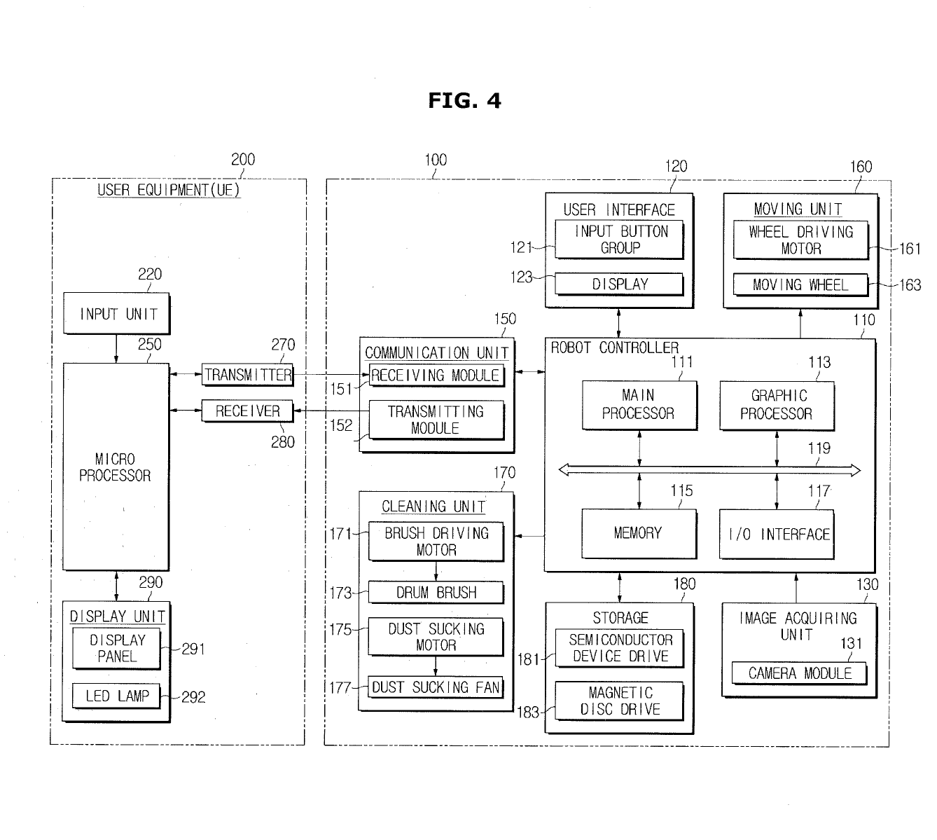

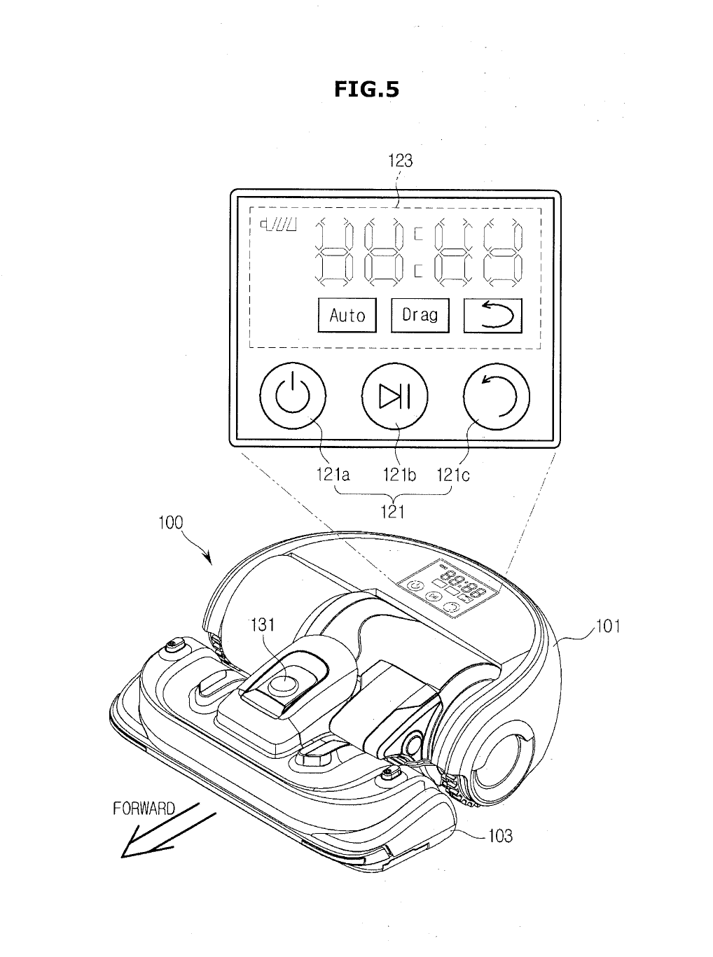

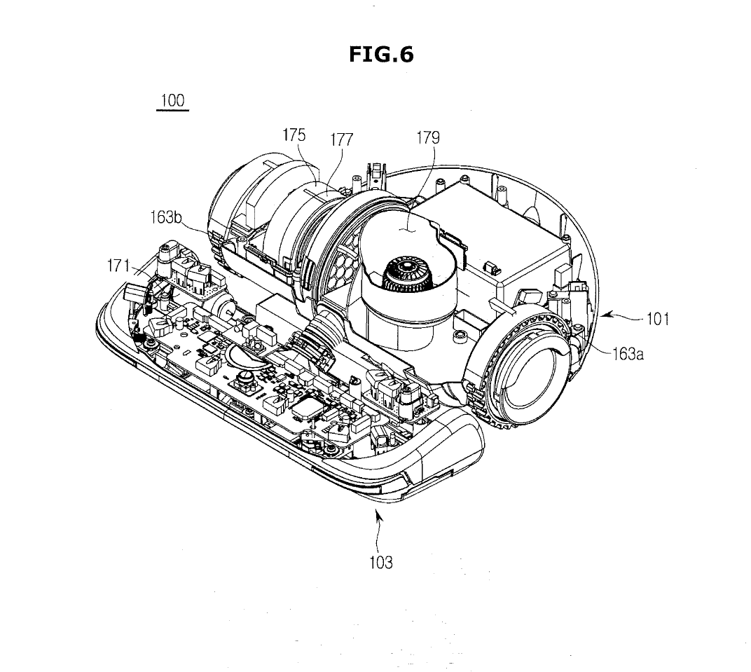

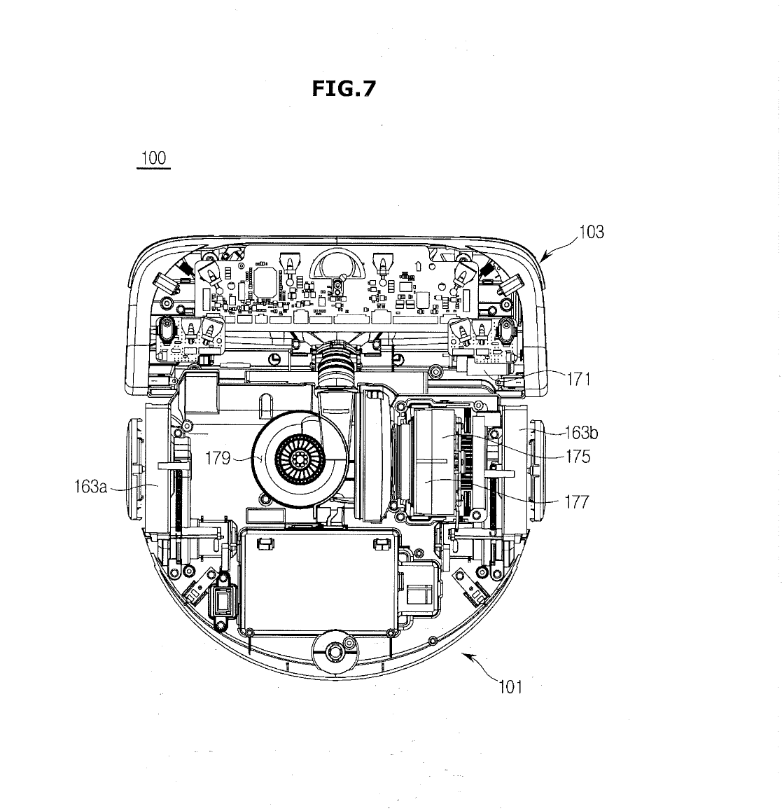

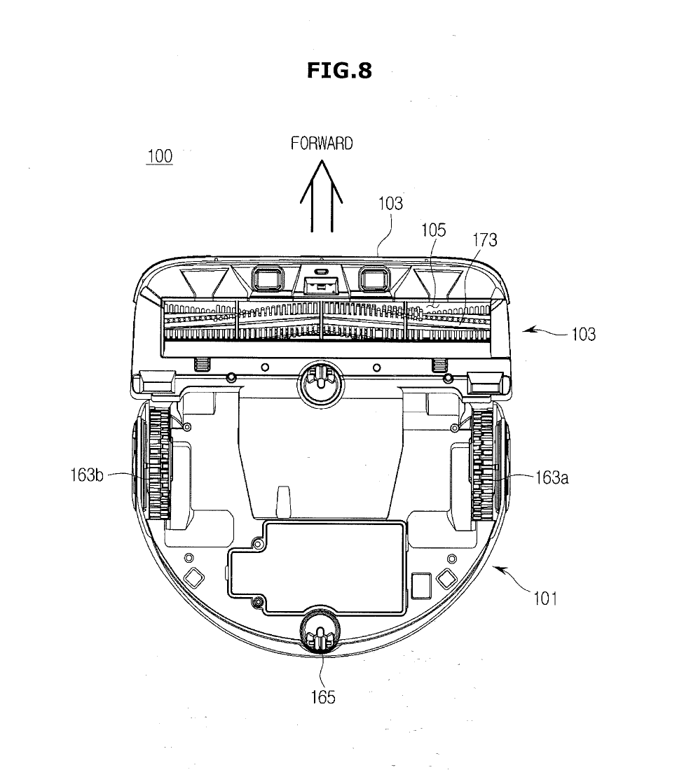

FIG. 4 is a control block diagram of a UE and cleaning robot, according to an embodiment of the present disclosure. FIG. 5 is a perspective view of the exterior of a cleaning robot, according to an embodiment of the present disclosure, FIGS. 6 and 7 are perspective views of the interior of a cleaning robot, according to an embodiment of the present disclosure, and FIG. 8 is a perspective view of the bottom of a cleaning robot, according to an embodiment of the present disclosure.

Referring to FIGS. 4 to 8, the cleaning robot 100 may include a main body 101 and a sub body 103. As shown in FIG. 5, the main body 101 may be shaped like a semi-circle, and the sub body 103 may be shaped like a rectangle.

Inside and outside of the main body 101 and sub body 103, there may be constituent parts for implementing functionalities of the cleaning robot 100.

Specifically, the cleaning robot 100 may include a user interface 120 for interacting with the user, an image acquiring unit 130 for acquiring surrounding images of the cleaning robot 100, a communication unit 150 for performing wireless communication with the UE 200, a moving unit 160 for moving the cleaning robot 100, a cleaning unit 170 for performing cleaning, a storage 180 for storing programs and various data, and a robot controller 110 for controlling overall operation of the cleaning robot 100.

The user interface 120 may be arranged on the top face of the main body 101 of the cleaning robot 100, as shown in FIG. 5, and may include input buttons 121 for receiving control inputs from the user, and a display unit 123 for displaying information about operation of the cleaning robot 100.

The input buttons 121 may include a power button 121a for tuning on or off the cleaning robot 100, a start/stop button 121b for starting/stopping operation of the cleaning robot 100, and a return button 121c for returning the cleaning robot 100 to a charging station (not shown).

The buttons included in the input button 121 may employ push switches for detecting pressure of the user, membrane switches, or touch switches for detecting contacts of a body part of the user.

The display unit 123 may display information of the cleaning robot 100 corresponding to a control command input by the user. For example, the display unit 123 may display a state of operation of the cleaning robot 100, power state, cleaning mode selected by the user, whether the cleaning robot 100 is returning to the charging station, etc. The state of operation of the cleaning robot 100 may include not only a state of when the cleaning robot 100 is moving to perform cleaning but also a state of whether the cleaning robot 100 has received a radio communication signal related to a control command of the user. The display unit 123 may display at least one of whether the cleaning robot 100 has received a radio communication signal, whether the cleaning robot 100 is moving, or whether the cleaning robot 100 has arrived at a position where there is the UE 200, which may be transmitted from the cleaning robot 100 to the UE 200.

The display unit 123 may employ self-radiating Light Emitting Diodes (LEDs) or Organic Light Emitting Diodes (OLEDs), a Liquid Crystal Display (LCD) equipped with a separate light source, or the like.

Although not shown, the user interface 120 may include a touch screen panel (TSP) able to receive a control command from the user and display operation information corresponding to the control command in some embodiments.

The touch screen panel may include a display for displaying operation information and a control command entered by the user, a touch panel for detecting coordinates that comes in contact with a body part of the user, and a touch screen controller for determining a control command entered by the user based on the coordinates of contact detected by the touch panel.

The image acquiring unit 130 may include a camera module 131 for acquiring surrounding images of the cleaning robot 100.

The camera module 131 may be arranged on the top of the sub body 103 included in the cleaning robot 100, and may include a lens for focusing the light irradiated from above of the cleaning robot 100, and an image sensor for converting light into an electric signal.

The image sensor may employ a Complementary Metal Oxide Semiconductor (CMOS) sensor or a Charge Coupled Device (CCD) sensor.

Especially, the camera module 131 may convert a surrounding image of the cleaning robot 100 to an electric signal that may be processed by the robot controller 110, and send the electric signal corresponding to an upper image to the robot controller 110. The image provided by the image acquiring unit 130 may be used to detect a position of the cleaning robot 100.

The communication unit 150 may include a receiving module 151 for receiving a radio communication signal from the UE 200, and a transmitting module 152 for transmitting a radio communication signal to the UE 200. There may be a single receiving module 151 or a plurality of receiving modules 151 included in the communication unit 150. The receiving module 151 may receive a wireless communication signal transmitted from the UE 200, and the transmitting module 152 may transmit information regarding e.g., a state of operation of the cleaning robot 100 to the UE 200.

Specifically, the user may input a control command related to an operation of the cleaning robot 100 or a call command to move the cleaning robot 100 by means of the UE 200. The input control command or call command may be transmitted from a transmitter 270 of the UE 200 in the form of a radio communication signal and received by the receiving module 151 of the cleaning robot 100. The radio communication signal transmitted from the UE 200 may be transmitted multiple times while the cleaning robot 100 is moving around.

Furthermore, in the case that there are a plurality of receiving modules 151, a distance between the UE 200 and the cleaning robot 100 may be determined based on the radio communication signal received by the plurality of receiving modules 151 at the same time, and based on the determined distance, a direction of the UE 200 may be determined.

As will be described below, the distance between the cleaning robot 100 and the UE 200 may be determined based on the intensity of the radio communication signal received by the receiving module 151, and the direction of the UE 200 may be determined by combining pieces of distance information between the UE 200 and the cleaning robot 100 determined based on the intensities of the radio communication signal received multiple times by the receiving module 151.

The communication unit 150 may forward the radio communication signal received from the UE 200 to the robot controller 110. The cleaning robot 100 may then be moved to a location where there is the UE 200 under the control of the robot controller 100.

The cleaning robot 100 may transmit information about a state of operation of the cleaning robot 100 to the UE 100 through the transmitting module 152 of the communication unit 150 under the control of the robot controller 110, and a receiver 280 of the UE 200 may receive the information and forward it to the microprocessor 250. Specifically, the transmitting module 152 may send the UE 200 at least one piece of information about whether the receiving module 151 of the cleaning robot 100 has received a radio communication signal transmitted from the UE 200, whether the cleaning robot 100 is moving, and whether the cleaning robot 100 has arrived at a location where there is the UE 200 according to a call command of the user.

The communication unit 150 may communicate data with the transmitter 270 and the receiver 280 of the UE 200 according to various wired/wireless communication protocols.

The moving unit 160 moves the cleaning robot 100 and may include, as shown in FIGS. 6 to 8, wheel driving motors 161, moving wheels 163, and a caster wheel 165.

The moving wheels 163 may be equipped on either ends of the bottom of the main body 101, including left- and right-moving wheels 163a and 163b arranged on the left and right of the cleaning robot 100, respectively, with respect to the front of the cleaning robot 100.

The moving wheels 163 may receive turning force from the wheel driving motors 161 to move the cleaning robot 100.

The wheel driving motors 161 may generate turning force to turn the moving wheels 163, and include left- and right-driving motors 161a and 161b to turn the left- and right-moving wheels 163a and 163b, respectively.

The left- and right-driving motors 161a and 161b may each receive a driving control signal from the robot controller 110 and operate independently.

With the independently operating left- and right-driving motors 161a and 161b, the left- and right-moving wheels 163a and 163b may turn independently from each other.

The independent operation of each of the left- and right-moving wheels 163a and 163b may enable various motions of the cleaning robot 100, such as forward motions, reverse motions, turning motions, turning motions in place, and the like.

For example, while both the left- and right-driving wheels 163a and 163b are turning in the first direction, the cleaning robot 100 may go straight forward, and while both the left- and right-driving wheels 163a and 163b are turning in the second direction, the main body 101 may move go straight backward.

When the left- and right-moving wheels 163a, 163b are turning in the same direction at different speeds, the cleaning robot 100 may move to the right or left, and when the left- and right-moving wheels 163a, 163b are turning in different directions, the cleaning robot 100 may turn clockwise or counterclockwise in the same place.

The caster wheel 165 may be mounted on the bottom of the main body 101, and the rotation shaft of the caster wheel 165 may be rotated based on the direction in which the cleaning robot 100 is moving. Wth the rotation shaft rotated based on the moving direction of the cleaning robot 100, the caster wheel 165 may enable the cleaning robot 100 to be moved steadily without interfering with the motion of the cleaning robot 100.

In addition, the moving unit 160 may include a motor driving circuit (not shown) for supplying a driving current to the wheel driving motor 163 based on a control signal from the robot controller 110, a power transfer module (not shown) for transferring turning force of the wheel driving motor 161 to the moving wheel 163, a rotation detection sensor (not shown) for detecting an angular displacement and rotating speed of the wheel driving motor 161 or moving wheel 163, etc.

The cleaning unit 170 may include a drum brush 173 for scattering dust on the floor in the cleaning area, a brush driving motor 171 for turning the drum brush 173, a dust sucking fan 177 for sucking in the scattered dust, a dust sucking motor 175 for turning the dust sucking fan 177, and a dust bin 179 for storing the dust sucked.

The drum brush 173 may be mounted in the dust inlet 105 formed on the bottom of the sub body 103, as shown in FIG. 8, for scattering dust on the floors into the dust inlet 105 while being rotated around the rotation shaft arranged in parallel with the bottom of the sub body 103.

The brush driving motor 171 may be mounted to be adjacent to the drum brush 173 for rotating the drum brush 173 according to a cleaning control signal from the robot controller 110.

Although not shown, the cleaning unit 170 may further include a motor driving circuit for supplying a driving current to the brush driving motor 171 according to a control signal from the robot controller 110, and a power transfer module for transferring a turning force of the brush driving motor 171 to the drum brush 173.

The dust sucking fan 177 may be mounted in the main body 101, as shown in FIGS. 6 and 7, for sucking the dust scattered by the drum brush 173 into the dust bin 179.

The dust sucking motor 175 may be mounted in a position close to the dust sucking fan 177 for rotating the dust sucking fan 177 according to a control signal from the robot controller 110.

Although not shown, the cleaning unit 170 may further include a motor driving circuit for supplying a driving current to the dust sucking motor 175 based on a control signal from the robot controller 110, and a power transfer module for transferring a turning force of the dust sucking motor 175 to the dust sucking fan 177.

The dust bin 179 may be mounted in the main body 101, as shown in FIGS. 6 and 7, for storing the dust sucked in by the dust sucking fan 177.

Furthermore, the cleaning unit 170 may include a dust guide tube for guiding dust sucked in through the dust inlet 105 of the sub body 103 to the dust bin 179 mounted in the main body 101.

The storage 180 may store a control program and control data to control the cleaning robot 100, and map information of a space to be cleaned, which is obtained while the cleaning robot 100 is moving about. The storage 180 may also store information about attenuation ratios of radio communication signal intensities over distance between the UE 200 and the cleaning robot 100, as described above in connection with FIGS. 3A and 3B. Moreover, the storage 180 may store information about a plurality of coordinate values that correspond to distances between the cleaning robot 100 and the UE 200, which may be determined based on the intensity of the radio communication signal.

The storage 180 may serve as an auxiliary memory device to assist a memory included in the robot controller 110 as will be described below, and may be implemented as a non-volatile storage medium that preserves the stored data even when the power to the cleaning robot 100 is out.

The storage 180 may include a semiconductor device drive 181 for storing data in a semiconductor device, a magnetic disc drive 183 for storing data in a magnetic disc, etc.

The robot controller 110 may control overall operation of the cleaning robot 100.

Specifically, the robot controller 110 may include an input/output (I/O) interface 117 for interfacing data in/out between the robot controller 110 and the respective components included in the cleaning robot 100, a memory 115 for storing programs and data, a graphic processor 113 for performing image processing, and a main processor 111 for performing computational operation according to the program and data stored in the memory 113. The robot controller 110 may further include a system bus 119 enabling communication among the main processor 111, the I/O interface 117, the memory 115, and the graphic processor 113.

The I/O interface 117 may receive an image from the image acquiring unit 130, results of detecting contacts sensed by the contact detector (not shown), etc., and forward them to the main processor 111, the graphic processor 113, and the memory 115 via the system bus 119.

In addition, the I/O interface 117 may forward various control signals output from the main processor 111 to the moving unit 160 or cleaning unit 170.

The memory 115 may store a control program and control data for controlling operation of the cleaning robot 100 by fetching them from the storage 180.

The memory 115 may include volatile memories, such as Static Random Access Memories (S-RAMs), Dynamic RAMs (D-RAMs), or the like. It is, however, not limited thereto, and in some embodiments, the memory 115 may include a non-volatile memory such as a flash memory, a Read Only Memory (ROM), an Erasable Programmable Read Only Memory (EPROM), a Electrically Erasable Programmable Read Only Memory (EEPROM), etc.

The graphic processor 113 may convert an image obtained by the image acquiring unit 130 into a format to be stored in the memory 115 or storage 180, or may change the resolution or size of the image obtained by the image acquiring unit 130. Furthermore, the graphic processor 113 may convert a reflected light image obtained by the obstacle detecting module 140 into a format to be processed by the main processor 111.

The main processor 111 may process detection results of the contact detector (not shown) and images acquired by the image acquiring unit 130 according to the program and data stored in the memory 115, or perform computational operation to control the moving unit 160 and the cleaning unit 170.

For example, the main processor 111 may calculate a position of the cleaning robot 100, or a direction, a distance and size of the obstacle, based on the image acquired by the image acquiring unit 130.

Furthermore, the main processor 111 may perform operation to determine whether to avoid or contact the obstacle based on the direction, distance and size of the obstacle. If it is determined to avoid the obstacle, the main processor 111 may calculate a traveling route to avoid the obstacle, or otherwise if it is determined to contact the obstacle, the main processor 111 may calculate a traveling route to align the cleaning robot 100 with the obstacle.

In addition, the main processor 111 may create motion control data to be provided to the moving unit 160 in order for the cleaning robot 100 to be moved along the calculated traveling route.

The robot controller 110 may determine a location of the UE 200 based on the intensity of the radio communication signal received by the receiving module 151 of the communication unit 150 from the UE 200. Specifically, the robot controller 110 may determine a distance between the UE 200 and the cleaning robot 100 based on correlations in which the intensity of a radio communication signal received from the UE 200 varies with the distance between the cleaning robot 100 and the UE 200. Since the information about the correlations of the intensity of radio communication signals over the distance between the UE 200 and the cleaning robot 100 as described in connection with FIGS. 3A and 3B is stored in the storage 180, the robot controller 110 may determine the distance between the UE 200 and the cleaning robot 100 based on the information stored in the storage 180.

Once the distance between the UE 200 and the cleaning robot 100 is determined, the robot controller 110 may determine a direction of the UE 200 by combining pieces of the determined distance information.

Furthermore, the robot controller 110 may control the transmitting module 152 of the communication unit 150 to transmit information about a state of operation of the cleaning robot 100 to the UE 200.

Moreover, the robot controller 110 may control the moving unit 160 to move the cleaning robot 100 across the floors to be cleaned, and control the moving unit 160 to move the cleaning robot 100 to a location where there is the UE 200 based on the radio communication signal received from the UE 200. In addition, the robot controller 110 may control the cleaning unit 170 for the cleaning robot 100 to clean the floor to be cleaned while moving around.

Operation of the cleaning robot 100, as will be described below, may be interpreted as operation controlled by the robot controller 110.

The UE 200 may include a microprocessor 250 for controlling overall operation of the UE 200, an input unit 220 for receiving control commands for the UE 200 or for the cleaning robot 100 from the user, a transmitter 270 for transmitting radio communication signals to the cleaning robot 100, a receiver 280 for receiving radio communication signals from the cleaning robot 100, and a display unit 290 for displaying a state of operation of the cleaning robot 100.

The user may input a control command to control the UE or cleaning robot 100 through the input unit 220. Specifically, the user may input a call command to move the cleaning robot 100 to a location of the user, and may input a control command to wirelessly transmit the input call command to the cleaning robot 100.

The transmitter 270 may transmit a radio communication signal to the cleaning robot 100 based on the call command for the cleaning robot 100 input by the user through the input unit 220. As described above, various communication schemes, such as Radio Frequency (RF), Wireless Fidelity (Wi-Fi), Bluetooth, Zigbee, near field communication (NFC), Ultra Wide Band (UWB) communications, etc., may be employed for the wireless communication, but are not limited thereto as long as the UE 200 and the cleaning robot 100 may exchange wireless communication signals.

The receiver 280 may receive information about a state of operation of the cleaning robot 100, which is transmitted by the cleaning robot 100, and the display unit 290 may include at least one of the display panel 291 and the LED lamp to indicate the information about the state of operation of the cleaning robot 100.

The microprocessor 250 may control overall operation of the UE 200. Specifically, based on the call command for the cleaning robot 100 received from the user through the input unit 220, the microprocessor 250 may control the transmitter 270 to transmit a radio communication signal corresponding to the call command to the cleaning robot 100. Furthermore, based on the information about a state of operation of the cleaning robot 100 received by the receiver 280 from the cleaning robot 100, the microprocessor 250 may control the display unit 290 to display the state of operation of the cleaning robot 100.

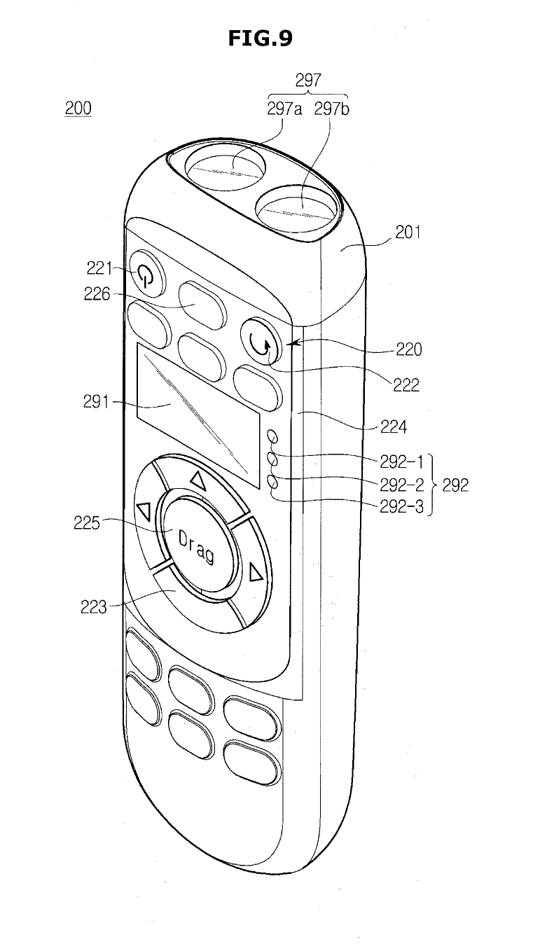

FIG. 9 is a perspective view of the exterior of a UE, according to an embodiment of the present disclosure.

Referring to FIG. 9, the UE 200 may include an input unit 220 for receiving a control command from the user, a display panel 291 and LED lamps 292 for indicating a state of operation of the cleaning robot 100.

The input unit 220 may receive a control command from the user and may be formed in the upper part of the main body 201 that constitutes the exterior of a remote device 200.

The input unit 220 may include a power button 221 for powering on/off the cleaning robot 100, a return button 222 for returning the cleaning robot 100 to a charging station (not shown) to charge power, a start/stop button 223 for starting or stopping operation of the cleaning robot 100, a plurality of cleaning mode buttons 224 for selecting a cleaning mode of the cleaning robot 100, a call button 226 for inputting a control command to call the cleaning robot 100 to a location of the user, etc. The user may input the control command to move the cleaning robot 100 to the location of the user by pressing the call button 226. Furthermore, the input unit 220 may include a drag button 225 for inputting a drag command to move the cleaning robot 100 along a traveling route indicated by the user.

The buttons included in the input unit 220 may employ push switches for detecting pressure of the user, membrane switches, or touch switches for detecting contacts of a body part of the user.

The display panel 291 may display a state of operation of the cleaning robot 100 operating under a control command input by the user, and in an embodiment of the present disclosure, may display the state of operation of the cleaning robot 100 operating under a call command of the user in various methods, e.g., in text or patterns.

The LED lamp 292 may indicate a state of operation of the cleaning robot 100 operating under a control command input by the user, and in an embodiment of the present disclosure, may indicate the state of operation of the cleaning robot 100 operating under a call command of the user by turning on the lamp for the user to intuitively recognize the state. Specifically, a signal reception lamp 292-1 may indicate whether the cleaning robot 100 has received a radio communication signal transmitted by the UE 200; a motion lamp 292-2 may indicate whether the cleaning robot 100 is moving to a position called by the user; a motion complete lamp 292-3 may indicate whether the cleaning robot 100 has arrived at the position called by the user.

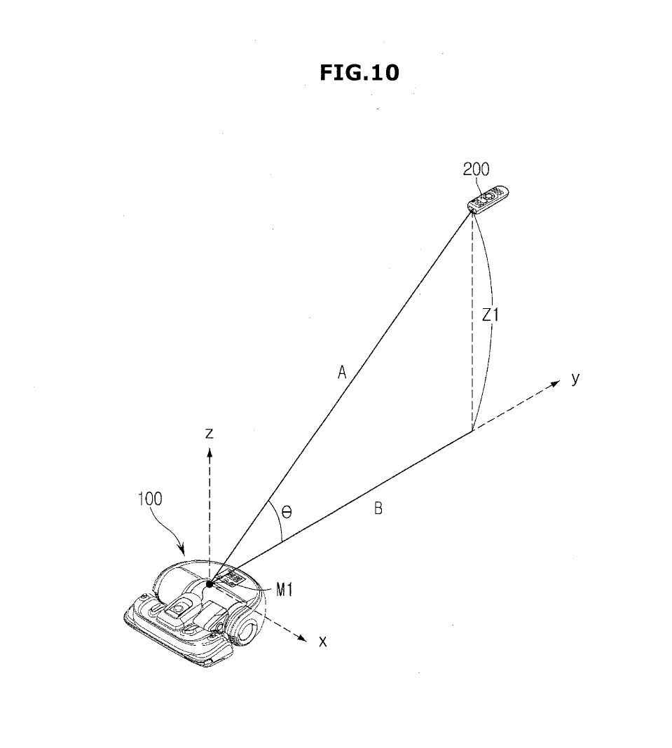

FIG. 10 conceptually illustrates a cleaning robot receiving a radio communication signal with a single receiving module, according to an embodiment of the present disclosure.

Referring to FIG. 10, the user may use the UE 200 to send a call command to the cleaning robot 100. Specifically, the user may press the call button 226 included in the input unit 220 of the UE 200 to input a control command to call the cleaning robot 100, and the transmitter 270 may then wirelessly transmit the call command to the cleaning robot 100.

The receiving module 151 of the cleaning robot 100 may receive the call command transmitted from the UE 200 and forward the call command to the robot controller 110.

The receiving module 151 included in the cleaning robot 100 may be implemented as a single one or multiple ones, but in FIG. 10, it is assumed that there is a single receiving module 151. Furthermore, there are no limitations on the position where the receiving module 151 is to be installed in the cleaning robot 100, but in FIG. 10, for convenience of explanation, it is assumed that the receiving module 151 is located in a center part M1 of the cleaning robot 100.

A radio communication signal may be transmitted from the UE 200 in various forms, but in FIG. 10, it is assumed that the radio communication signal is transmitted straightly.

In the case that the center part M1 of the cleaning robot 100 receives the radio communication signal of a call command, a distance in a straight line between the UE 200 and the cleaning robot 100 is denoted as ‘A’.

If the UE 200 is located at a distance of a certain height Z1 from the floor, the radio communication signal received by the receiving module 151 of the cleaning robot 100 may have a certain angle θ to the floor while the distance in a straight line along which the cleaning robot 100 actually needs to be moved to the location of the UE 200 corresponds to B. The distance B is equal to A cos θ.

The robot controller 110 may determine a location of the UE 200 based on the intensity of the radio communication signal received by the receiving module 151 of the cleaning robot 100. Based on data of correlations in which the intensity of the radio communication signal varies with the distance between the UE 200 and the cleaning robot 100, as described above in connection with FIGS. 3A and 3B, the distance A between the UE 200 and the cleaning robot 100 may be determined. In other words, the robot controller 110 may measure the intensity of the radio communication signal received by the receiving module 151, and determine the distance between the cleaning robot 100 and the UE 200 based on data about attenuation ratios of signal intensities over the distance, which is stored in the storage 180.

As described above, the distance in a straight line A based on the intensity of the radio communication signal received by the cleaning robot 100 from the UE 200 is different from the actual distance in a straight line B along which the cleaning robot 100 actually needs to be moved to the location of the user, and thus the robot controller 110 may determine the distance in a straight line B by itself based on the equation B=A cos θ. In practice, however, since there is little difference between the distances A and B and the user may minutely control the motion of the cleaning robot 100 by the user's manipulation or by the use of a light spot tracking scheme when the cleaning robot 100 is moved to a place close to the location of the UE 200, the robot controller 110 may determine A to be the distance between the UE 200 and the cleaning robot 100.

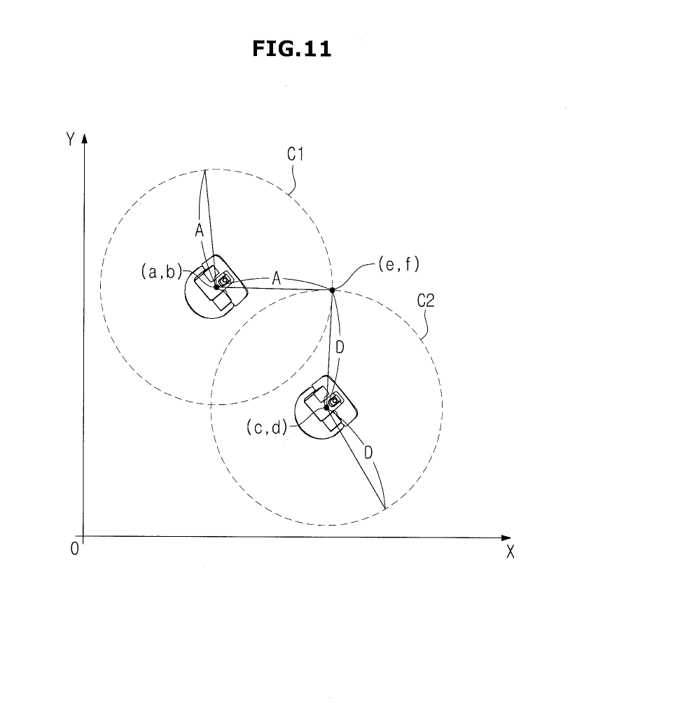

FIG. 11 illustrates a coordinate plane conceptually representing a method for determining a direction of a UE by combining pieces of distance information between the UE and a cleaning robot with a single receiving module, according to an embodiment of the present disclosure.

Referring to FIG. 11, the cleaning robot 100 viewed from above may be represented on a coordinate plane with x and y axes.

If the cleaning robot 100 receives a radio communication signal at a first position (a, b) on the coordinate plane, a circle C1 of coordinates having a radius corresponding to the distance A between the cleaning robot 100 and the UE 200 determined based on the intensity of the radio communication signal as described above in connection with FIG. 10 may be drawn. That is, the robot controller 110 may obtain information about the coordinates at the distance A from the first position (a, b) of the cleaning robot 100, based on the location information of the cleaning robot 100 stored in the storage 180.

The cleaning robot 100 may be moved to another position after receiving the radio communication signal, and a distance to be moved may be short or distant. Referring to FIG. 11, the cleaning robot 100 may be moved to a second position (c, d) from the first position (a, b), and may receive the radio communication signal from the UE 200 multiple times while being moved to the second position (c, d).

Once the cleaning robot 100 is moved to the second position (c, d), the robot controller 110 may determine a distance D between the cleaning robot 100 and the UE 200 from the second position (c, d) based on the intensity of the radio communication signal received by the receiving module 151 as in FIG. 10.

The robot controller 110 may represent a circle C2 of coordinates having a radius corresponding to the distance D between the cleaning robot 100 and the UE 200 determined at the second position (c, d). That is, the robot controller 110 may obtain information about the coordinates at the distance D from the second position (c, d) of the cleaning robot 100, based on the location information of the cleaning robot 100 stored in the storage 180.

The robot controller 110 may detect coordinate values corresponding to a point of intersection between the coordinates obtained when the cleaning robot 100 is located at the first and second positions (a, b) and (c, d), and determine the point of intersection as a direction of the UE 200. That is, referring to FIG. 11, a point represented in coordinates (e, f) may be a direction of the UE 200.

The receiving module 151 may receive the radio communication signal multiple times in real time while the cleaning robot 100 is moving, and the robot controller 110 may control the cleaning robot 100 to be moved to a point determined by determining the direction and distance to the point where the UE 200 is located based on the intensity of the radio communication signal received by the robot controller 110.

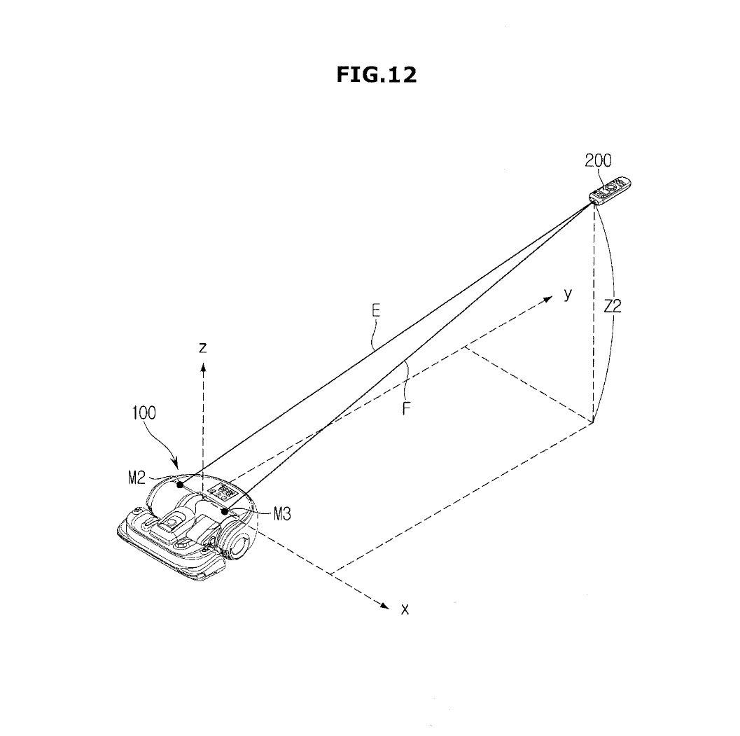

FIG. 12 conceptually illustrates a cleaning robot receiving a radio communication signal with two receiving modules, according to an embodiment of the present disclosure.

As shown in FIG. 12, the user may transmit a call command to the cleaning robot 100 by means of the UE 200, and the receiving module 151 of the cleaning robot 100 may receive the call command transmitted from the UE 200 and forward the call command to the robot controller 110.

Referring to FIG. 12, unlike the case of FIG. 10, there may be multiple receiving modules 151 installed in the cleaning robot 100, and for convenience of explanation, it is assumed herein that there are two receiving modules 151.

There is no limitation on the position where the two receiving modules 151 are to be installed in the cleaning robot 151, but in FIG. 12, it is assumed, for convenience of explanation, that the receiving modules 151 are located on either sides M2, M3 of the cleaning robot 100.

In the case that the side parts M2, M3 of the cleaning robot 100 receive the radio communication signal of a call command, distances in straight lines between the UE 200 and the cleaning robot 100 are denoted as ‘E’ and ‘F’.

If the UE 200 is located at a distance of a certain height Z2 from the floor, radio communication signals received by the receiving modules 151 of the cleaning robot 100 may each have a certain angle θ to the floor, as described above in connection with FIG. 10. Thus, there may be a difference between a distance in a straight line along which the cleaning robot 100 actually needs to be moved to the location of the UE 200 and the actual distance E or F. In practice, however, since there is little difference between the distances to be moved and the actual distance, and the user may minutely control the motion of the cleaning robot 100 by the user's manipulation or by the use of a light spot tracking scheme when the cleaning robot 100 is moved to a place close to the location of the UE 200, the robot controller 110 may determine the distance between the UE 200 and the cleaning robot 100 to be E or F.

The robot controller 110 may determine a location of the UE 200 based on the intensity of the radio communication signal received by the receiving module 151 of the cleaning robot 100 at the locations M2 and M3. Based on data of correlations in which the intensity of the radio communication signal varies with the distance between the UE 200 and the cleaning robot 100, the distances E and F between the UE 200 and the cleaning robot 100 may be determined.

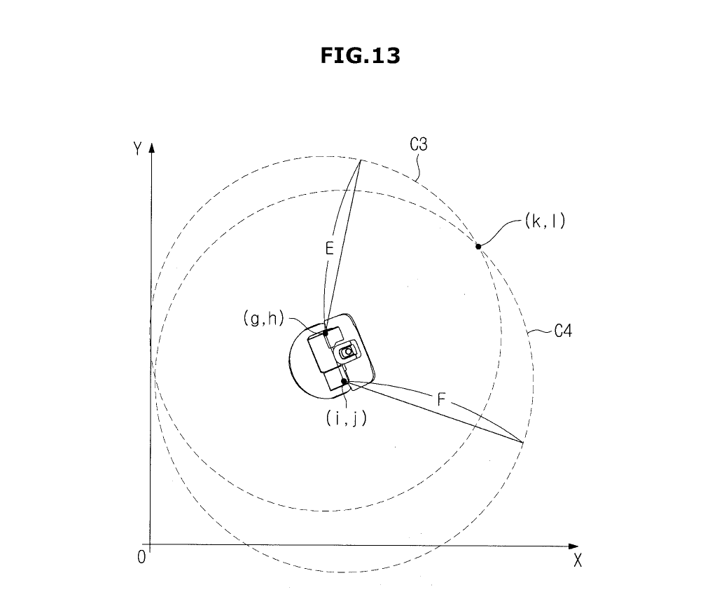

FIG. 13 illustrates a coordinate plane conceptually representing a method for determining a direction of a user equipment by combining pieces of distance information between the user equipment and a cleaning robot with two receiving modules, according to an embodiment of the present disclosure.

Referring to FIG. 13, the cleaning robot 100 viewed from above may be represented on a coordinate plane with x and y axes.

In the case that one of the receiving modules 151 located at positions M2, M3 on either sides of the cleaning robot 100 receives a radio communication signal at a position (g, h) on the coordinate plane, a circle C3 of coordinates having a radius corresponding to the distance E between the cleaning robot 100 and the UE 200 determined based on the intensity of the radio communication signal may be drawn. That is, the robot controller 110 may obtain information about the coordinates located at the distance E from the receiving module 151 that receives the radio communication signal at the position (g, h), based on the location information of the cleaning robot 100 stored in the storage 180.

Furthermore, in the case that the other of the receiving modules 151 located at positions M2, M3 on either sides of the cleaning robot 100 receives a radio communication signal at a position (i, j) on the coordinate plane, a circle C4 of coordinates having a radius corresponding to the distance F between the cleaning robot 100 and the UE 200 determined based on the intensity of the radio communication signal may be drawn. That is, the robot controller 110 may obtain information about the coordinates located at the distance F from the receiving module 151 that receives the radio communication signal at the position (i, j), based on the location information of the cleaning robot 100 stored in the storage 180.

The cleaning robot 110 may detect coordinate values corresponding to a point of intersection between the coordinates obtained by the multiple receiving modules 151 located at the positions (g, h) and (i, j), and determine the point of intersection as a direction of the UE 200. That is, referring to FIG. 13, a point represented in coordinates (k, l) may be a direction of the UE 200.

As described above, in the case that the cleaning robot 100 includes multiple receiving modules 151, the cleaning robot 100 may receive the radio communication signal one time with the multiple receiving modules 151 without need to receive the radio communication signal multiple times while moving around, and determine a distance between the UE 200 and the cleaning robot 100 and the direction of the UE 200 based on the intensity of the radio communication signal received by the respective receiving modules 151.

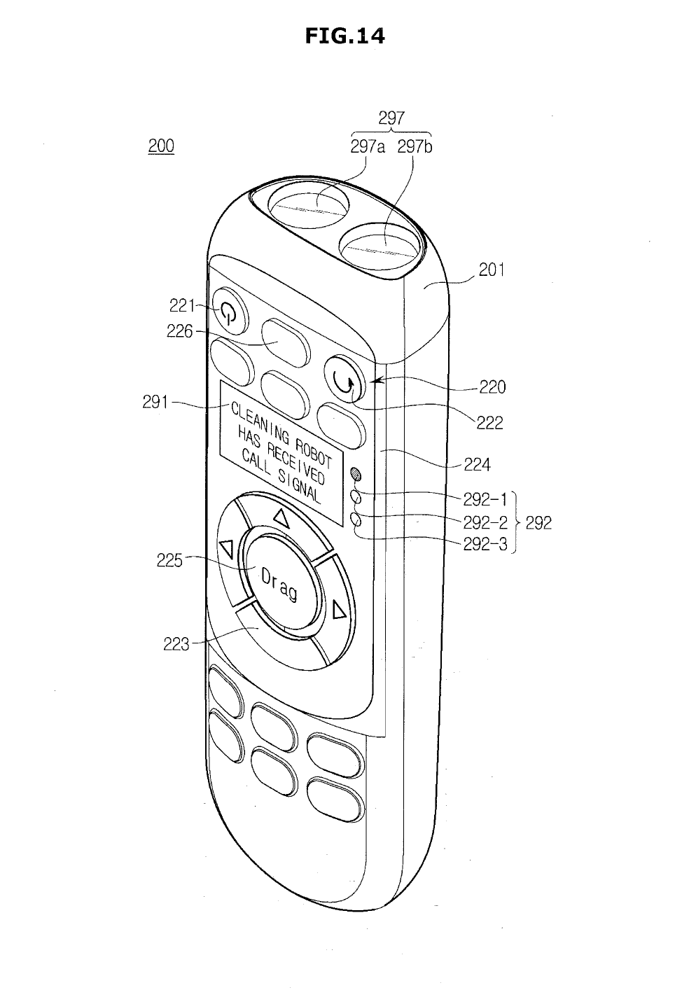

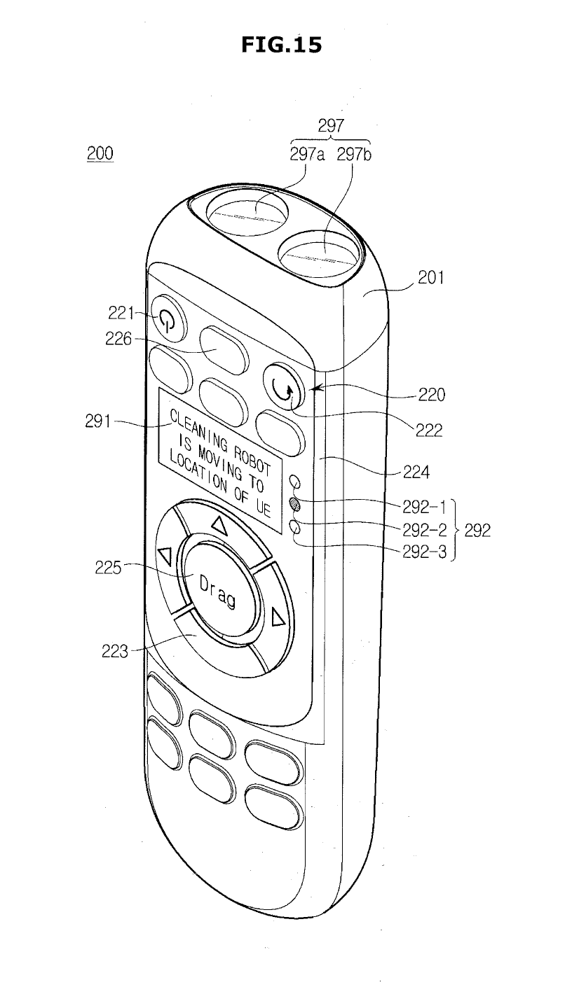

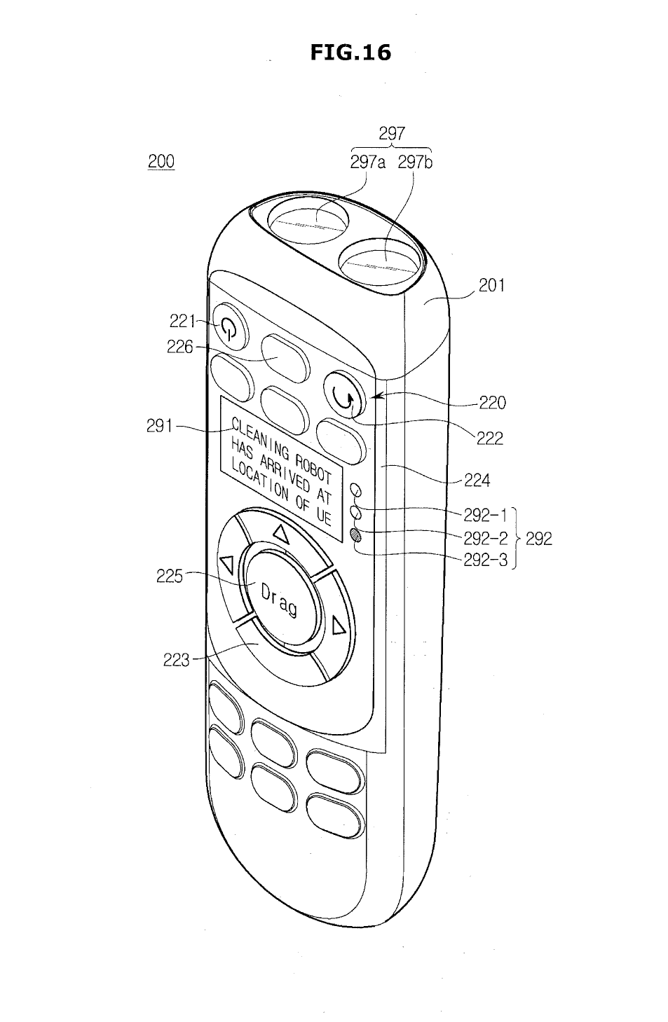

FIG. 14 illustrates a display unit of a UE displaying whether a cleaning robot has received a radio communication signal from the UE, according to an embodiment of the present disclosure. FIG. 15 illustrates a display unit of a UE displaying whether a cleaning robot is moving to a position of the user, according to an embodiment of the present disclosure, and FIG. 16 illustrates a display unit of a UE displaying whether a cleaning robot has arrived at a position of the UE, according to an embodiment of the present disclosure.

The transmitting module 152 included in the communication unit 150 of the cleaning robot 100 may transmit information about a state of operation of the cleaning robot 100 to the UE 200 under the control of the robot controller 110.

The receiver 280 of the UE 200 may receive the information about the state of operation of the cleaning robot 100 wirelessly transmitted from the transmitting module 152 and forward the information to the microprocessor 250.

As described above with respect to the previous embodiments, the cleaning robot 100 may receive the radio communication signal from the UE 200, and determine a distance between the UE 200 and the cleaning robot 100 and a direction of the UE 200 to move to the location of the UE 200. In the middle of the respective processes, the cleaning robot 100 may transmit information about a state of operation of the cleaning robot 100 to the UE 200 in real time.

Based on the information about a state of operation of the cleaning robot 280 received by the receiver 280, the microprocessor 250 may control the display unit 290 to display the state of operation of the cleaning robot 100.

As described above in connection with FIG. 9, the UE 200 may include the display panel 291 and the LED lamp 292 as the display unit 290. The display panel 291 may display the state of operation of the cleaning robot 100 in various methods, such as in text or patterns, and the LED lamp 292 may indicate the state of operation of the cleaning robot 100 by turning on the lamp. The LED lamp 292 may come in different color according to the state of operation of the cleaning robot 100.

Referring to FIG. 14, the display panel 291 of the UE 200 may display whether the cleaning robot 100 has received a radio communication signal from the UE 200 in text.

Also, whether the cleaning robot 100 has received the radio communication signal from the UE 200 may be intuitively indicated by turning on the signal reception lamp 292-1 of the LED lamp 292.

Referring to FIG. 15, the display panel 291 of the UE 200 may display whether the cleaning robot 100 is moving to a position called by the user in text. The text displayed on the display panel 291 in FIG. 14 about whether the radio communication signal has been received may be changed into text as shown in FIG. 15 if the cleaning robot 100 starts moving.

Also, whether the cleaning robot 100 is moving to the position called by the user may be intuitively indicated by turning on the motion lamp 292-2 of the LED lamp 292.

Referring to FIG. 16, the display panel 291 of the UE 200 may display whether the cleaning robot 100 has arrived at the position called by the user in text. The text displayed on the display panel 291 in FIG. 15 about whether the cleaning robot 100 is moving may be changed into text as shown in FIG. 16 if the cleaning robot 100 has just arrived at the position called by the user.

Also, whether the cleaning robot 100 has arrived at the position called by the user may be intuitively indicated by turning on the motion complete lamp 292-3 of the LED lamp 292.

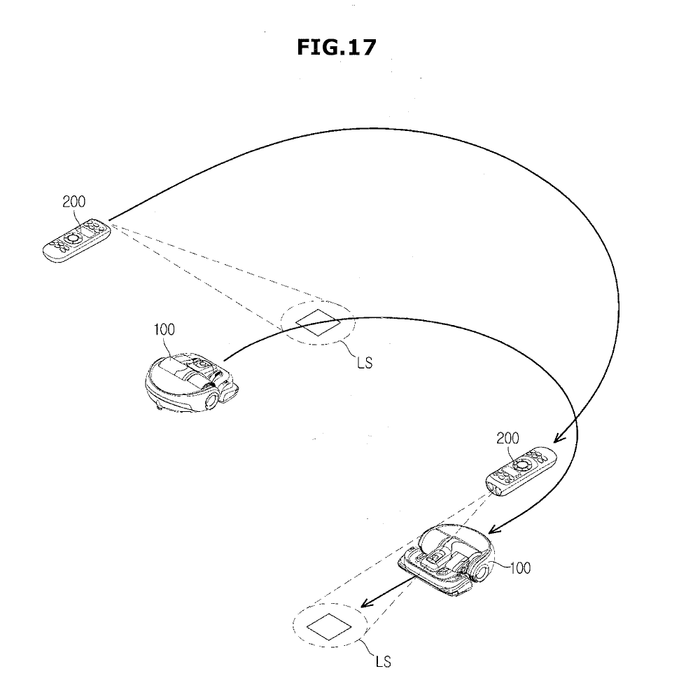

FIG. 17 conceptually illustrates a UE remotely controlling a cleaning robot, according to an embodiment of the present disclosure.

In accordance with the embodiments of the present disclosure as described above, the user may wirelessly send a call command to the cleaning robot 100 with the UE 200, and the cleaning robot 100 may determine the distance between the cleaning robot 100 and the UE 200 and the direction of the UE 200 based on the intensity of the radio communication signal to move to a point called by the user.

In this regard, as described above in connection with FIG. 10, there may be an error between the distance between the cleaning robot 100 and the UE 200 calculated by the robot controller 110 of the cleaning robot 100 and an actual distance over which the cleaning robot 100 is to be moved to the called position. Accordingly, if the cleaning robot 100 has moved to a place close to the position called by the user, the user may remotely control the cleaning robot 100 with the UE 200 to move to a desired position, as shown in FIG. 17.

Briefly explaining operation of the cleaning robot 100 remotely controlled by the user with the UE 200 as shown in FIG. 9, the user may first input a control command to control the cleaning robot 100 with the UE 200 and the UE 200 may then forward the control command to the cleaning robot 100.

Furthermore, the UE 200 may modulate an infrared ray and irradiate the modulated infrared ray through the lens module 197, according to the control command input by the user. Wth the UE 200, the user may not only input a control command for the cleaning robot 100 but also designate a location for the cleaning robot 100 to be moved to.

For example, when the user inputs a drag command, the UE 200 may modulate an infrared ray and irradiate the modulated infrared ray, according to the drag command. The cleaning robot 100 may receive the drag command by receiving and demodulating the modulated infrared ray. Once the drag command is received, the cleaning robot 100 may be moved to the direction in which the modulated infrared ray is received. In other words, the cleaning robot 100 may follow the location indicated by the user with the UE 200.

The infrared ray irradiated by the UE 200 may carry a control command to the cleaning robot 100 as well as provide the cleaning robot 100 with a location indicated by the user.

Furthermore, the UE 200 may irradiate a visible ray to indicate the location indicated by the UE 200 to the user. That is, the user may use the UE 200 to indicate a location for the cleaning robot 100 to be moved to, and the UE 200 may irradiate a visible ray toward the location indicated by the user.

The visible ray and infrared ray irradiated by the UE 200 may be projected onto the floor to be cleaned to form a Light Spot (LS), as shown in FIG. 17. The user and the cleaning robot 100 may recognize the location indicated by the UE 200 through the LS.

When the user changes the location to a new location with the UE 200, the cleaning robot 100 may detect the new location indicated by the UE 200 and move to the new location. Specifically, the cleaning robot 100 may perform drag motion to follow the LS, a position indicated by the UE 200, and the user may move the cleaning robot 100 to a desired location through the LS tracking scheme within a short range.

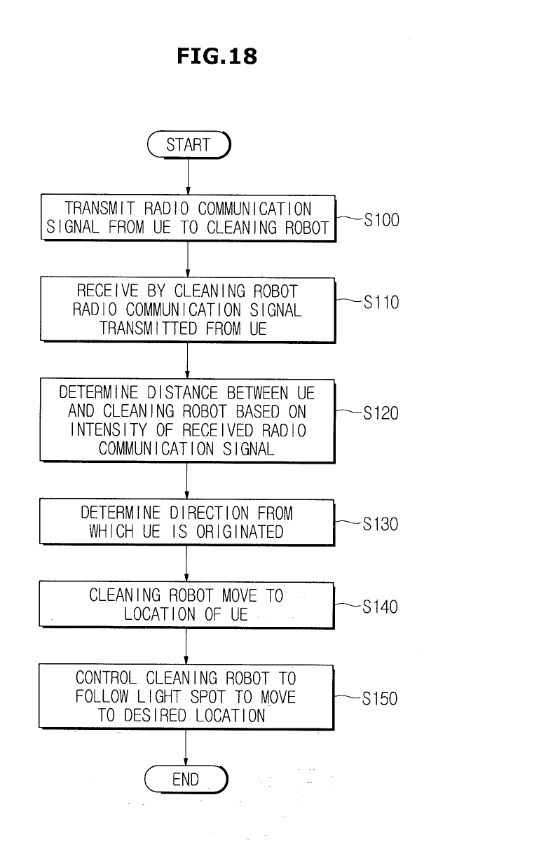

FIG. 18 is a flowchart illustrating a method for controlling a cleaning robot, according to an embodiment of the present disclosure.

Referring to FIG. 18, the user may send the cleaning robot 100 a call command to wirelessly call the cleaning robot 100 with the UE 200 (S100).

The receiving module 151 included in the communication unit 150 of the cleaning robot 100 may receive a radio communication signal transmitted from the UE (S110). In this regard, the cleaning robot 100 may receive the radio communication signal multiple times while on the move. The receiving module 151 may be implemented as a single one or multiple ones, and in the case there are multiple receiving modules 151, the receiving modules 151 may each receive the radio communication signal.

The robot controller 110 may determine a distance between the UE 200 and the cleaning robot 100 based on the intensity of the radio communication signal received from the UE 200, as described above in connection with FIGS. 3A and 3B (S120).

The robot controller 110 may determine a direction of the UE 200 by combining pieces of distance information between the UE 200 and the cleaning robot 100, as described above in connection with FIGS. 10 to 13 (S130). In the case that there is a single receiving module 151 in the cleaning robot 100, the robot controller 110 may determine a distance between the UE 200 and the cleaning robot 100 and a direction of the UE 200 , based on the radio communication signal received multiple times while the cleaning robot 100 is on the move. Furthermore, in the case that there are multiple receiving modules 151 in the cleaning robot 100, a direction of the UE 200 may be determined by combining pieces of distance information between the UE 200 and the cleaning robot 100 determined based on the intensity of the radio communication signal received by the respective receiving modules.

Once the location and direction of the UE 200 are determined, the robot controller 110 may control the moving unit 160 to move the cleaning robot 100 to the location of the UE 200 (S140).

When the cleaning robot 100 is moving to the location called by the user, the user may use the UE 200 to control the cleaning robot 100 to follow the LS, and in this manner, may remotely control the cleaning robot 100 to be moved to a desired location (S150).

When the cleaning robot 100 receives a radio communication signal from the UE 200 and moves to the location of the UE 200, the cleaning robot 100 may transmit a radio communication signal to the UE 200 when it has arrived at the location called by the user, and the display panel 291 or LED lamp 292 of the UE 200 may display a state of operation of the cleaning robot 100 received by the receiver 280.

Embodiments of a UE, cleaning robot including the UE and method for controlling the cleaning robot have thus far been described with reference to the accompanying drawings. However, the present disclosure is not limited to the embodiments, which are only by way of example in all respects. According to embodiments of the present disclosure, the user may use a UE to transmit a long distance radio communication signal to a cleaning robot, and thus may be able to call the cleaning robot even if the cleaning robot is far distant from the UE or if there is an obstruction between the UE and the cleaning robot, thereby improving user convenience. Furthermore, a need for the user to additionally manipulate the cleaning robot to move to a desired location may be eliminated. Several embodiments have been described, but a person of ordinary skill in the art will understand and appreciate that various modifications can be made without departing the scope of the present disclosure. Thus, it will be apparent to those ordinary skilled in the art that the disclosure is not limited to the embodiments described, which have been provided only for illustrative purposes.

What is claimed is:

1. A cleaning robot comprising:
a main body;
a moving unit to move the main body;
a communication unit to perform wireless communication with a user equipment (UE); and
a robot controller to determine a location of the UE based on intensity of a radio communication signal received by the communication unit,
wherein the robot controller is configured to control the moving unit to move the main body to the determined location of the UE in response to the location of the UE being determined.

2. The cleaning robot of claim 1, wherein the communication unit comprises:
at least one receiving module to receive a radio communication signal from the UE; and
a transmitting module to transmit a radio communication signal to the UE.

3. The cleaning robot of claim 2, wherein the robot controller is further configured to:
determine that a distance between the UE and the main body decreases when the intensity of the radio communication signal increases, and
determine that a distance between the UE and the main body increases when the intensity of the radio communication signal decreases.

4. The cleaning robot of claim 2, wherein the robot controller is further configured to:
determine a direction of the UE using information about a distance between the UE and the main body determined based on the intensity of a radio communication signal received by the receiving module multiple times while the main body is moving.

5. The cleaning robot of claim 4, wherein the robot controller is further configured to:
determine a direction of the UE by detecting a point of intersection between a plurality of coordinate values corresponding to a distance between the UE and the main body when the main body is at a first location and a plurality of coordinate values corresponding to a distance between the UE and the main body when the main body is at a second location.

6. The cleaning robot of claim 2, wherein the robot controller is further configured to:
determine a direction of the UE using information about a distance between the UE and the main body determined based on the intensity of the radio communication signal received by each receiving module when the at least one receiving module comprises a plurality of receiving modules.

7. The cleaning robot of claim 2, wherein the transmitting module is configured to transmit at least one piece of information about whether the receiving module has received the radio communication signal, whether the main body has moved, or whether the main body has arrived at the determined location of the UE to the UE.

8. The cleaning robot of claim 3, further comprising a storage to store information about correlations in which the intensity of the radio communication signal varies with the distance between the UE and the main body.

9. A method for controlling a cleaning robot that includes a main body, a moving unit for moving the main body, and at least one receiving module for receiving a radio communication signal from the UE, the method comprising:
by at least one controller, receiving a radio communication signal from the UE;
determining a location of the UE based on intensity of the received radio communication signal; and
controlling the moving unit to move the main body to the determined location of the UE based on the determined location of the UE.

10. The method of claim 9, wherein the determining of a location of the UE based on intensity of the received radio communication signal comprises:
determining that a distance between the UE and the main body decreases when the intensity of the radio communication signal increases, and
determining that a distance between the UE and the main body increases when the intensity of the radio communication signal decreases.

11. The method of claim 9, wherein the determining of a location of the UE based on intensity of the received radio communication signal comprises:
determining a direction of the UE using information about a distance between the UE and the main body determined based on intensity of a radio communication signal received multiple times while the main body is moving.

12. The method of claim 11, wherein the determining of a direction of the UE comprises detecting a point of intersection between a plurality of coordinate values corresponding to a distance between the UE and the main body when the main body is at a first location and a plurality of coordinate values corresponding to a distance between the UE and the main body when the main body is at a second location.

13. The method of claim 9, wherein the determining of a direction of the UE comprises determining a direction of the UE using information about a distance between the UE and the main body determined based on the intensity of the radio communication signal received by each receiving module when the at least one receiving module is provided in plural.

14. The method of claim 9, further comprising, by the at least one controller, transmitting a radio communication signal to the UE.

15. The method of claim 14, wherein the transmitting of the radio communication signal to the UE comprises:
transmitting at least one piece of information about whether the receiving module has received the radio communication signal, whether the main body is moving, or whether the main body has arrived at the determined location of the UE to the UE.

16. A user equipment (UE) comprising:
a transmitter to transmit a radio communication signal to call a cleaning robot to a location of the UE;
a receiver to receive a radio communication signal about a state of operation of the cleaning robot from the cleaning robot; and
a display unit to display a state of operation of the cleaning robot based on a radio communication signal received from the cleaning robot.

17. The UE of claim 16, wherein the display unit is configured to display at least one of whether the cleaning robot has received the radio communication signal, whether the cleaning robot has moved, or whether the cleaning robot has arrived at the location of the UE.

18. The UE of claim 17, wherein the transmitter is configured to:
transmit a radio communication signal multiple times while the cleaning robot is moving toward the UE.

19. The UE of claim 16, further comprising an input unit to receive a command to transmit a radio communication signal to call the cleaning robot to the location of the UE to the cleaning robot.

20. The UE of claim 19, further comprising a microprocessor to control transmission of the radio communication signal to the cleaning robot based on the command received through the input unit, and to display a state of operation of the cleaning robot based on a radio communication signal received from the cleaning robot.
